(19) United States
(12) Patent Application Publication
(10) Pub. No.: US 2014/0265468 A1
(43) Pub. Date: Sep. 18, 2014

(54) ADJUSTABLE RIDING SEAT

(71) Applicants: Mark Greenhill, Winnetka, IL (US); Daniel Dodson, Palatine, IL (US)

(72) Inventors: Mark Greenhill, Winnetka, IL (US); Daniel Dodson, Palatine, IL (US)

(21) Appl. No.: 13/800,898

(22) Filed: Mar. 13, 2013

(51) Int. Cl. B62J 1/02

(52) U.S. Cl. CPC B62J 1/02
USPC 297/208

(57) ABSTRACT

An adjustable seat for a riding device includes a frame adapted to be attached to the riding device. A saddle has an underside and a fastening mechanism is attached to the underside of the saddle. A spring seat is attached to the frame. A removable compression spring is positioned between the fastening mechanism and the spring seat. The fastening mechanism is adjustable so that a compression of the spring between the fastening mechanism and the spring seat may be adjusted.

### FIELD OF THE INVENTION

The present invention relates generally to accessories for bicycles, exercise equipment and riding devices and, in particular, to an adjustable riding seat having springs where the configuration of the springs can be adjusted to alter the shock absorption properties of the seat to obtain a desired level of comfort for a rider.

### BACKGROUND

Riding seats are used regularly on bicycles, spinning equipment, and other types of exercise equipment or riding devices. Generally, the rider sits on the saddle of the seat, and the underside of the seat is connected to a seat post that is fastened into the seat tube of the bicycle or other exercise riding equipment. In the ease of a bicycle, during use, vibration transferred from the ground is transferred to the rider via the tires, wheels, seat tube, and the seat post. The amount of vibration transferred to the rider can affect the rider's comfort level, as can the rider's specific anatomy—such as height, weight, and gender.

A comfortable seal is required in order for the rider to enjoyably ride and power the bicycle, riding device or exercise equipment for an extended period of time. As a result, modern bicycle seats typically have some level of support, providing shock absorption, and rider comfort. While different varieties, of foam padding and gels, strategic arrangement of padding, elastomer bumpers and a variety of springs may be used, for this purpose, most bicycle seats utilize a combination of padding and metal or elastomer springs to provide rider comfort and shock absorption.

As noted above, however, human being anatomy is slightly different from person to person in the way the body contacts the saddle of the seat, and riding conditions (i.e. surface and terrain characteristics) may differ. As a result, nearly an infinite number of specific seat needs or preferences exist. Differing types of padding (foam or gel) and spring configurations may address some of these needs, but a single seat, with a single associated padding and spring configuration, will only address the specific needs of a limited number of riders. In other words, a single riding seat configuration will only provide a limited number of riders with a “best choice” so be or she can sit on, and pedal the bicycle or exercise riding equipment in a tolerable comfort zone for an extended period of time. As a result, the rider is often required to try many different riding seats before finding one that provides; the most comfort for his or her anatomy and the riding conditions. Even then, the rider may have to change the seat if the riding conditions change. A need therefore exists for a riding seat that may be adjusted so that switching between alternative riding seats, both during selection of a seat and use of the bicycle, riding device or exercise equipment under changing conditions, may be avoided.

### BRIEF DESCRIPTION OF TEE DRAWINGS

FIG. 1 is side perspective view of an embodiment of the adjustable riding seat of the invention;

FIG. 2 is a perspective view of the frame portion and springs of the adjustable riding seat of FIG. 1;

FIG. 3 is a perspective exploded view of an adjustable spring assembly of the adjustable riding seat of FIG. 1;

FIG. 4 is a bottom perspective view of the adjustable riding seat of FIG. 1 with the frame portion omitted;

FIG. 5 is a bottom perspective view of the adjustable riding seat of FIG. 1;

FIGS. 6A and 6B are rear perspective views of the seat of FIGS. 1 and 5 illustrating the springs in low compression and high compression configurations, respectively;

FIG. 7 is a perspective view illustrating an alternative set or pair of springs that may be used with the seat of FIGS. 1, 5, 6A and 6B.

### DETAILED DESCRIPTION OF EMBODIMENTS

An embodiment of the adjustable riding seat of the invention is indicated in general at 10 in FIG. 1. While the adjustable riding seat of the invention will be described below in terms of a bicycle seat, it is to be understood that the seat may be used with other exercise equipment or riding devices including, but not limited to, stationary bicycles and spinning equipment. As illustrated in FIG. 1, the seat includes a saddle 12 and a frame 14 connected to the underside of the saddle. The saddle 12 preferably features a padded top surface. The padding may include foam, gel or any other padding arrangement known in the art.

As illustrated in FIG. 2, the frame 14 features a pair of elongated rails 22a and 22b that join at their leading ends to form a V-shaped leading end portion 23 of the frame. The rails 22a and 22b are clamped to the top portion of a seat post through any conventional clamping or attachment member known in the art. The seat post is then received within the seat tube of the bicycle frame. Examples of the seat and seat post mountings are provided in U.S. Pat. No. 8,317,261 to Walsh, the contents of which are hereby incorporated by reference. The frame rails 22a and 22b may be formed from a single piece of metal wire or two or more metal wire portions that are joined. Materials other than metal wire including, but not limited to, composite materials, may be used for the frame rails 22a and 22b.

A spring seat 24a is mounted to the trailing end of the frame rail 22a, while spring seat 24b is mounted to the trailing end of frame rail 22b. Spring seat 24a includes an annular channel 26a surrounding a central aperture 27a, while spring seat 24b is similarly provided with annular channel 26b surrounding, central aperture 27b.

As is known in the art, the V-shaped portion 23 of the frame 14 is received by a bracket (illustrated in phantom at 28 in FIG. 1) positioned on the underside of the leading portion of the saddle 12.

As illustrated in FIG. 2, a pair of compression springs 32a and 32b are sized to engage the annular channels 26a and 26b of the spring seats 24a and 24b. The springs are preferably wave springs, and can include single turn type wave springs, crest-to-crest wave springs, nested wave springs, or a combination thereof. Crest-to-crest wave springs can include shim ends, but could also not have shim ends. The springs can be constructed of various materials known in the art and may be used in various diameters, thickness, width, height, quantity, and assortment.

With reference to FIG. 3, spring 32a is part of an adjustable spring assembly, indicated in general at 34a. In addition to spring 32a, the adjustable spring assembly includes a fastening member, indicated in general at 36a, an actuator, such as a thumb wheel, indicated in general at 38a and a fastening knob, indicated in general at 42a.

As illustrated in FIG. 3, fastening member 36a includes a base portion 44a that is attached to the underside 46 of the saddle (12 in FIG. 1) by adhesive, welding, fasteners or other arrangements known in the art. Positioned upon the base portion of the fastening member is externally threaded stud 48a. A barrel portion 52a, featuring a threaded bore 54a, is positioned on the stud 48a.

The actuator, which in this embodiment is a thumb wheel 38a features a ribbed or knurled circumferential surface 56a and a threaded central opening 58a passing there through. In addition, the thumb wheel includes an annular recess 62a that surrounds the central opening and is sized to receive an end of the spring 32a, as illustrated in FIG. 4. The threads of central opening 58a are compatible with the external threads of stud 48a so that the thumb wheel is movably positioned on the stud, as illustrated in FIG. 4.

Fastening knob 42a features an externally threaded post 64a attached to a disk, portion 66a that features a ribbed or knurled circumferential surface 68a. The threads of post 64a are compatible with the threads of bore 54a.

The assembled adjustable spring assembly of FIGS. 1 and 4 is indicated in general at 34a in FIG. 5. As described above and illustrated in FIG. 4, the thumb wheel 38a is positioned on the stud (48a in FIG. 3) of the fastening member with the threads of the thumb wheel central opening engaging the external threads of the stud. The spring 32a is positioned with an end of the spring received within the annular recess 62a (FIG. 3) of the thumb wheel. The barrel, portion 52a of the fastening member passes through the center of the spring, as illustrated in FIG. 4. Turning to FIG. 5, the spring seat 24a is then placed in engagement with the other end of the spring 32a so that the end of the spring is received within the annular channel (26a of FIG. 2) of the spring seat.

The post of the fastening knob (64a of FIG. 3) is then moved through, the spring seat aperture (27a of FIG. 2) and inserted within the bore 54a (FIGS. 3 and 4) of the barrel portion 52a (FIGS. 3 and 4) of the fastening member. As a result, the external threads of the post of the fastening knob engage the threads of the bore of the fastening member barrel portion. With reference to FIG. 5, the disk portion 66a of the fastening knob is then turned to secure the adjustable spring assembly 34a together, with spring 32a sandwiched between the thumb wheel 38a and the spring seat 24a. The disk portion 66a may optionally include an opening 72a that receives an Allen wrench or other fool to further tighten the engagement between the fastening knob and the fastening member.

Adjustable spring assembly 34b of FIGS. 4 and 5 features a construction similar to spring assembly 34a.

Adjustment of the compression of the springs 32a and 32b, and thus the force required to compress the springs 32a and 32b by a rider sitting on the saddle 12, will now be explained with regard to FIGS. 6A and 6B. In FIG. 6A, the springs 32a and 32b are in a low compression configuration, in that thumb wheels 38a and 38b are in positions generally adjacent to base portions 44a and 44b. As a result, the distances between thumb wheels 38a and 38b and spring seats 24a and 24b are maximized. When in this configuration the force required to compress the springs is less so that the seat provides a “softer” feel in that shocks are more easily absorbed.

The seat may be adjusted to provide a firmer feel by turning the thumb wheels 38a and 38b. Due to the threaded connection between the thumb wheels 38a and 38b and their corresponding studs 48a and 48b, which are mounted to the underside 46 of the saddle 12 in a fixed fashion by base portions 44a and 44b, the thumb wheels move into the positions illustrated in FIG. 6B. As a result, the distances between the thumb wheels 38a and 38b and their corresponding spring seats 24a and 24b are decreased, so that the springs 32a and 32b are compressed. When in this configuration, the force required to compress the springs is greater, so that the seat provides a “firm” feel in that shocks are less easily absorbed.

With reference to FIG. 7, a set of alternative compression springs 82a and 82b may be substituted for springs 32a and 32b if required to better suit the rider or riding conditions. The ease of disassembly of the adjustable spring assemblies 34a and 34b permits easy substitution of springs 82a and 82b for springs 32a and 32b.

While the preferred embodiments of the invention have been shown and described, it will be apparent to those skilled in the art that changes and modifications may be made therein without departing from the spirit of the invention, the scope of which is defined by the appended claims.

What is claimed is:

1. An adjustable seat for a riding device comprising:
a. a frame adapted to be attached to the riding device;
b. a saddle having an underside;
c. a fastening mechanism attached to the underside of the saddle;
d. a spring seat attached to the frame;
e. a spring positioned between the fastening mechanism and the spring seat;
f. said fastening mechanism adjustable so that a compression of the spring between the fastening mechanism and the spring seat may be adjusted.

2. The adjustable seat of claim 1 wherein the fastening device includes a stud with an actuator connected to the stud so that a position of the actuator along the stud may be adjusted.

3. The adjustable seat of claim 2 wherein the fastening device includes a base by which the stud is mounted to the underside of the saddle and further comprising a barrel portion attached to the stud and further comprising a fastening knob engaging the spring seat and the barrel portion so that the spring seat is secured to the fastening mechanism.

4. The adjustable seat of claim 3 wherein the stud includes external threads and the actuator includes a threaded opening that engages the external threads of the stud and wherein the barrel portion includes a threaded bore and the fastening knob includes a post with external threads that engage the threaded bore of the barrel portion.

5. The adjustable seat of claim 4 wherein the fastening knob includes a disk portion attached to the post, where the disk portion includes a fastening knob ribbed circumferential surface and wherein the actuator is a thumb wheel having a thumb wheel ribbed circumferential surface.

6. The adjustable seat of claim 2 wherein the stud includes external threads and the actuator includes a threaded opening that engages the external threads of the stud.

7. The adjustable seat of claim 6 wherein the actuator is a thumb wheel having a ribbed circumferential surface.

8. The adjustable seat of claim 1 wherein the spring is a compression spring.

9. The adjustable seat of claim 8 wherein the spring is a wave spring.

10. The adjustable seat of claim 1 wherein the frame includes a pair of fail members.

11. The adjustable seat of claim 1 wherein the spring is removably positioned between the fastening mechanism and the spring seat.

12. The adjustable seat of claim 11 further comprising an alternative spring that may be substituted for the spring.

13. The adjustable seat of claim 1 wherein the frame includes a leading portion and a trailing portion, and the leading portion of the frame is attached to the underside of the saddle.

14. An adjustable seat for a riding device comprising:
a. a frame adapted to be attached to the riding device, said frame having a leading end portion and a trailing end portion;
b. a saddle having an underside, with the leading end portion of the frame attached to the underside of the saddle;
c. a stud attached to the underside of the saddle;
d. an actuator connected to the stud so that a position of the actuator along the stud may be adjusted;
e. a spring seat attached to the trailing end portion of the frame and the stud;
f. a spring positioned between the actuator and the spring seat so that a compression of the spring between the actuator and the spring seat may be adjusted by adjusting the position the actuator along the stud.

15. The adjustable seat of claim 14 wherein the fastening device includes a base by which the stud is mounted to the underside of the saddle and further comprising a barrel portion attached to the stud and further comprising a fastening knob engaging the spring seat and the barrel portion so that the spring seat is secured to the fastening mechanism.

16. The adjustable seat of claim 15 wherein the stud includes external threads and the actuator includes a threaded opening that engages the external threads of the stud and wherein the barrel portion includes a threaded bore and the fastening knob includes a post with external threads that engage the threaded bore of the barrel portion.

17. The adjustable seat of claim 16 wherein the fastening knob includes a disk portion attached to the post, where the disk portion includes a fastening knob ribbed circumferential surface and wherein the actuator is a thumb wheel having a thumb wheel ribbed circumferential surface.

18. The adjustable seat of claim 14 wherein the stud includes external threads and the actuator includes a threaded opening that engages the external threads of the stud.

19. The adjustable seat of claim 18 wherein the actuator is a thumb wheel having a ribbed circumferential surface.

20. The adjustable seat of claim 14 wherein the spring is a compression spring.

21. The adjustable seat of claim 20 wherein the spring is a wave spring.

22. The adjustable seal of claim 14 wherein the frame includes a pair of rail members.

23. The adjustable seat of claim 14 wherein the spring is removably positioned between the fastening mechanism and the spring seat.

24. The adjustable seat of claim 23 further comprising an alternative spring that may be substituted for the spring.

25. The adjustable seat of claim 14 wherein the riding device is a bicycle.
